(19) United States
(12) Patent Application Publication
(10) Pub. No.: US 2024/0389208 A1
(43) Pub. Date: Nov. 21, 2024

(54) ADAPTIVE CONTROL OF LIGHTING THAT UTILIZES REMOVABLE DIFFUSERS

(71) Applicant: Videndum Production Solutions Inc., Shelton, CT (US)

(72) Inventors: David Pasko, Middlebury, CT (US); Michael Herbert, London (GB); Benjamin Rosenfeld, Shelton, CT (US); Andrew John Sincic, Canoga Park, CA (US); Mark Advento, Santa Clarita, CA (US)

(21) Appl. No.: 18/625,848

(22) Filed: Apr. 3, 2024

Related U.S. Application Data
(60) Provisional application No. 63/503,043, filed on May 18, 2023.

(51) Int. Cl. H05B 47/105; H05B 45/10; H05B 45/20

(52) U.S. Cl. CPC H05B 47/105; H05B 45/10; H05B 45/20

(57) ABSTRACT

In one aspect, a controller for dynamically adjusting an optical output of a light is provided. The controller is configured to modify an operation of a at least one light emitting diode (LED) of the light. The controller is further configured to store a plurality of diffuser models that specify a pre-defined optical output of the light, each diffuser model corresponding to a different one of a plurality of diffusers installable at the light. The controller is further configured to identify, from the plurality of diffusers, which diffuser of the plurality of diffusers is installed at the light, select a corresponding diffuser model of the plurality of diffuser models based on which diffuser is installed, and modify the operation of at least one driver of the at least one LED based on the corresponding diffuser model to generate the pre-defined optical output of the light.

### CROSS-REFERENCE TO RELATED APPLICATIONS

This application claims priority to U.S. Provisional Patent Application No. 63/503,043, filed May 18, 2023, and titled “ADAPTIVE CONTROL OF LIGHTING THAT UTILIZES REMOVABLE DIFFUSERS”, which is hereby incorporated by reference in its entirety.

### BACKGROUND

The field of the disclosure relates to lighting, and more particularly, to lighting that utilizes removable diffusers.

Lighting systems are used in many scenarios to provide high-quality lighting for use in still picture, video, and film production environments. An array of light emitting diodes (LEDs) may be arranged on a LED light to provide the desired lighting. LEDs are energy efficient and last longer than other types of lighting systems, such as incandescent lights or fluorescent lights. However, an array of LEDs may generate harsh or uneven light, and a softer more even lighting may be desired by an end-user. Diffusers are often used to customize the lighting effects provided by LED lighting, with different diffusers modifying color temperatures, irradiance patterns, optical outputs, etc., of the LED(s). However, when the customer replaces the diffuser on the LED lighting, the LED lighting may subsequently generate a different color temperature and/or brightness than what is desired.

Thus, it would be desirable to provide mechanisms for utilizing removable diffusers in LED lighting while maintaining the color temperature and/or optical output for LED lighting.

### BRIEF DESCRIPTION

In one aspect, a controller for dynamically adjusting an optical output of a light is provided. The controller comprises at least one driver, a memory, and at least one processor. The at least one driver is configured to modify an operation of the at least one LED. The memory is configured to store a plurality of diffuser models that specify a pre-defined optical output of the light, where each diffuser model corresponds to a different one of a plurality of diffusers installable at the light. The at least one processor is configured to identify, from the plurality of diffusers installable at the light, which diffuser of the plurality of diffusers is installed at the light. The at least one processor is further configured to select a corresponding diffuser model of the plurality of diffuser models based on which diffuser is installed and modify the operation of the at least one driver based on the corresponding diffuser model to generate the pre-defined optical output of the light.

In another aspect, a method of dynamically adjusting an optical output of a light is provided. The method comprises identifying a plurality of diffuser models that specify a pre-defined optical output of the light, where each diffuser model corresponds to a different one of a plurality of diffusers installable at the light. The method further comprises identifying, from the plurality of diffusers installable at the light, which diffuser of the plurality of diffusers is installed at the light and modifying an operation of at least one driver of the at least one LED based on the corresponding diffuser model to generate the pre-defined optical output of the light.

In another aspect, a system comprising a light, a plurality of diffusers, and a controller is provided. The light comprises at least one LED. Each of the plurality of diffusers is installable at the light in an optical output path of the at least one LED. The controller comprises at least one driver and a memory. The at least one driver is configured to modify an operation of the at least one LED. The memory is configured to store a plurality of diffuser models that specify a pre-defined optical output of the light, where each diffuser model corresponds to a different one of the plurality of diffusers installable at the light. The controller is configured to identify, from the plurality of diffusers installable at the light, which diffuser of the plurality of diffusers is installed at the light, select a corresponding diffuser model of the plurality of diffuser models based on which diffuser is installed, and modify the operation of the at least one driver based on the corresponding diffuser model to generate the pre-defined optical output of the light.

### BRIEF DESCRIPTION OF DRAWINGS

These and other features, aspects, and advantages of the present disclosure will become better understood when the following detailed description is read with reference to the accompanying drawings in which like characters represent like parts throughout the drawings.

FIG. 1 depicts a block diagram of a system for control of lighting in an exemplary embodiment.

FIG. 2 depicts a block diagram of a controller for the light of the system of FIG. 1 in an exemplary embodiment.

FIG. 3 is an orthographic view of a light and a diffuser in an exemplary embodiment.

FIG. 4 depicts a bottom portion of the light of FIG. 3 in an exemplary embodiment.

FIG. 5 is an orthographic view of a side panel of the light of FIG. 3 in an exemplary embodiment.

FIG. 6 is a flow chart of a method of dynamically adjusting an optical output of at least one LED of a light in an exemplary embodiment.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the terms “processor” and “computer,” and related terms, e.g., “processing device,” “computing device,” and “controller” are not limited to just those integrated circuits referred to in the art as a computer, but broadly refers to a microcontroller, a microcomputer, an analog computer, a programmable logic controller (PLC), an application specific integrated circuit (ASIC), and other programmable circuits, and these terms are used interchangeably herein. In the embodiments described herein, “memory” may include, but is not limited to, a computer-readable medium, such as a random-access memory (RAM), a computer-readable non-volatile medium, such as a flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a touchscreen, a mouse, and a keyboard. Alternatively, other computer peripherals may also be used that may include, for example, but not be limited to, a scanner. Furthermore, in the example embodiment, additional output channels may include, but not be limited to, an operator interface monitor or heads-up display. Some embodiments involve the use of one or more electronic or computing devices. Such devices typically include a processor, processing device, or controller, such as a general-purpose central processing unit (CPU), a graphics processing unit (GPU), a microcontroller, a reduced instruction set computer (RISC) processor, an ASIC, a programmable logic controller (PLC), a field programmable gate array (FPGA), a digital signal processing (DSP) device, and/or any other circuit or processing device capable of executing the functions described herein. The methods described herein may be encoded as executable instructions embodied in a non-transitory computer readable medium, including, without limitation, a storage device and/or a memory device. Such instructions, when executed by a processing device, cause the processing device to perform at least a portion of the methods described herein. The above examples are not intended to limit in any way the definition and/or meaning of the term processor and processing device.

The use of removable diffusers on LED lighting is desired by end-users because it allows the end-users to vary the irradiance pattern of LED lighting to suit their specific lighting needs. However, end-users still expect that the LED lighting will provide an accurate output, even when the diffusers on the LED lights are changed. For example, a photographer may utilize a number of different diffusers that vary the irradiance pattern during a photo shoot, and the photographer expects that the color temperature and the optical output of the LED lights remain substantially constant from one diffuser to the next regardless of which diffuser is installed. However, changing the diffuser at the light may generate unexpected changes in the color temperature and/or optical output when different diffusers are installed at the light, which may negatively impact the images captured during the photography session.

In the embodiments described herein, these and other issues that may arise when removable diffusers are used in LED lighting are mitigated using diffuser models that are selected to dynamically adjust the color temperature and/or optical output of LED lights based on which removable diffuser is installed on the LED lights.

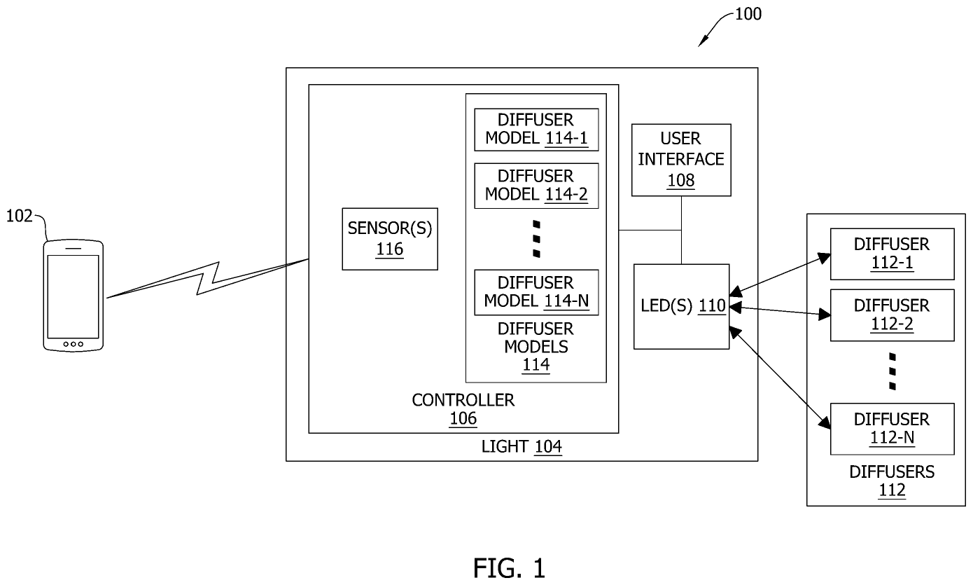

FIG. 1 depicts a block diagram of a system 100 for control of lighting in an exemplary embodiment. In this embodiment, system 100 includes a user device 102 which facilitates wireless control of at least one light 104. User device 102 may include, for example, a smart phone, a tablet, a dedicated hand-held device, and/or a computing device such as a personal computer. When user device 102 communicates with a universal mobile telecommunications system (UMTS), user device 102 may comprise user equipment (UE).

In this embodiment, user device 102 may be used to control the operation of light 104 of system 100 using wireless communication (e.g., using at least one radio frequency (RF) communication channel). The RF communication channel(s) may, for example, be implemented using Bluetooth, Bluetooth low energy (BLE), Wi-Fi, cellular networks, etc.

In some embodiments, system 100 is implemented in an audio/visual environment. For example, system 100 may be implemented in a still picture, a film, a television production environment, and/or a performance environment (e.g., a concert), etc.

Although system 100 depicts one light 104 in this embodiment, system 100 may include a different number of lights 104 in other embodiments. Light 104 may include multiple controllable color channels, each color channel configurable to vary a brightness of their color in order to vary the color temperature and/or optical output of light 104.

In this embodiment, light 104 includes a controller 106 that controls the operation of light 104 and communicates with user device 102. Controller 106 and light 104 may comprise any component, system, or device that performs the functionality described herein for controller 106 and light 104. Controller 106 and light 104 will be described with respect to various discrete elements, which perform functions. These elements may be combined in different embodiments, segmented into different discrete elements in other embodiments, or removed in some embodiments.

In some embodiments, light 104 further includes a user interface 108 which allows the end-user to control the operation of light 104 in addition to, or instead of, user device 102. User interface 108 may include displays, buttons, software defined buttons, etc., which may allow the end-user to navigate through various menu options presented by controller 106, such as menu options that allow the end-user to identify which of a plurality of diffusers are currently installed at light 104.

In this embodiment, light 104 further includes one or more LED(s) 110, which generate an optical output for light 104. LED(s) 110 may be organized into arrays that include lenses, which collate and concentrate the output of the LEDs. The lenses may be organized into one or more planar surfaces, forming a light emitting panel of LED(s) 110. LED(s) 110 may be organized into various color channels, with each color channel individually modifiable by controller 106 to vary the color temperature and/or optical output of light 104.

In this embodiment, system 100 further includes a plurality of diffusers 112. In this embodiment, three diffusers 112 are illustrated, corresponding to diffuser 112-1, diffuser 112-2, and diffuser 112-N, although in other embodiments system 100 may include a different number of diffusers 112. Diffusers 112 are removably attachable to light 104 such that diffusers 112 modify the optical output of light 104 if not corrected by controller 106.

In this embodiment, controller 106 dynamically adjusts the optical output of light 104 (e.g., controller dynamically adjusts the color temperature and/or brightness of light 104) based on diffuser models 114, each of which correspond to a different diffuser 112-1, 112-2, 112-N. In this embodiment, diffuser model 114-1 corresponds to diffuser 112-1, diffuser model 114-2 corresponds to diffuser 112-2, and diffuser model 114-N corresponds to diffuser 112-N. Although three diffuser models 114 are illustrated in this embodiment, controller 106 may utilize a different number of diffuser models 114 in other embodiments.

Generally, diffuser models 114 are utilized by controller 106 to modify an operation of LED(s) 110 of light 104 to adjust the optical output of light 104 depending on which of diffusers 112-1, 112-2, 112-N are installed at light 104. For example, controller 106 may utilize diffuser model 114-1 to modify the operation of LED(s) 110 when diffuser 112-1 is installed in the optical output path of LED(s) 110, may utilize diffuser model 114-2 to modify the operation of LED(s) 110 when diffuser 112-2 is installed in the optical output path of LED(s) 110, and may utilize diffuser model 114-N to modify the operation of LED(s) 110 when diffuser 112-N is installed in the optical output path of LED(s) 110.

In some embodiments, one or more of diffuser models 114 are generated during a manufacturing process for light 104 when light 104 is calibrated prior to being shipped to an end-user. In these embodiments, one or more of diffuser models 114 are associated with a unique instance of light 104, and one or more of diffuser models 114 may be different for different instances of the same type of light 104. In these embodiments, one or more of diffuser models 114 may be generated when each instance of light 104 is individually calibrated during manufacturing using one or more of diffusers 112. This process may improve the color temperature accuracy and brightness accuracy of lights 104, as each light 104 is individually calibrated for each diffuser 112. However, this process may not be as efficient and may entail additional production and calibration steps, which increases the manufacturing time for lights 104.

For example, diffuser model 114-1 may be generated during a calibration process of light 104 when diffuser 112-1 is installed on light 104 and light 104 is calibrated to achieve a pre-defined color temperature and/or brightness. In this embodiment, diffuser model 114-1 may be stored at controller 106, and diffuser model 114-1 defines how controller 106 modifies the operation of LED(s) 110 in order to achieve the pre-defined color temperature and/or brightness of light 104 when diffuser 112-1 is installed on light 104. In this embodiment, diffuser model 114-1 is unique to a particular light 104 and different lights 104 of the same type may have slightly different diffuser models 114-1 due to manufacturing and/or component variances when lights 104 are manufactured and calibrated.

In a similar manner, diffuser model 114-2 may be generated during a calibration process of light 104 when diffuser 112-2 is installed on light 104 and light 104 is calibrated to achieve a pre-defined color temperature and/or brightness. In this embodiment, diffuser model 114-2 may be stored at controller 106, and diffuser model 114-2 defines how controller 106 modifies the operation of LED(s) 110 in order to achieve the pre-defined color temperature and/or brightness of light 104 when diffuser 112-2 is installed on light 104. In this embodiment, diffuser model 114-2 is unique to a particular light 104 and different lights 104 of the same type may have slightly different diffuser models 114-2 due to manufacturing and/or component variances when lights 104 are manufactured and calibrated.

Similarly, diffuser model 114-N may be generated during a calibration process of light 104 when diffuser 112-N is installed on light 104 and light 104 is calibrated to a achieve a pre-defined color temperature and/or brightness. In this embodiment, diffuser model 114-N may be stored at controller 106, and diffuser model 114-N defines how controller 106 modifies the operation of LED(s) 110 in order to achieve the pre-defined color temperature and/or brightness of light 104 when diffuser 112-N is installed on light 104. In this embodiment, diffuser model 114-N is unique to a particular light 104 and different lights 104 of the same type may have slightly different diffuser models 114-N due to manufacturing and/or component variances when lights 104 are manufactured and calibrated.

In other embodiments, diffuser models 114 are generated by analyzing calibration data generated for a plurality of lights 104 for a particular diffuser 112-1, 112-2, 112-N, and diffuser models 114 are subsequently loaded into new lights 104 during manufacturing. For example, instead of calibrating light 104 for each diffuser 112-1, 112-2, 112-N during manufacturing, multiple lights 104 of the same type with diffusers 112-1, 112-2, 112-N installed are analyzed to generate diffuser models 114. In this embodiment, diffuser models 114 are the same or substantially the same for the same type of light 104. This process may improve production efficiency of lights 104, as each light 104 no longer is individually calibrated for each diffuser 112, which saves time during manufacturing.

For example, diffuser model 114-1 may be generated by installing diffuser 112-1 on a plurality of lights 104 that are the same type, calibrating the plurality of lights 104 to achieve a pre-defined color temperature and/or brightness, and generating a model that is a best fit for the plurality of lights 104 when diffuser 112-1 is installed. During subsequent manufacturing of lights 104 of the same type, diffuser model 114-1 may be stored at their corresponding controllers 106 (e.g., compiled into the firmware of controller 106), and calibrating individual lights 104 for diffuser 112-1 during the subsequent production process for light 104 may not be needed.

In a similar manner, diffuser model 114-2 may be generated by installing diffuser 112-2 on a plurality of lights 104 that are the same type, calibrating the plurality of lights 104 to achieve a pre-defined color temperature and/or brightness, and generating a model that is a best fit for the plurality of lights 104 when diffuser 112-2 is installed. During subsequent manufacturing of lights 104 of the same type, diffuser model 114-2 may be stored at their corresponding controllers 106 (e.g., compiled into the firmware of controller 106), and calibrating individual lights 104 for diffuser 112-2 during the subsequent production process for light 104 may not be needed.

Similarly, diffuser model 114-N may be generated by installing diffuser 112-N on a plurality of lights 104 that are the same type, calibrating the plurality of lights 104 to achieve a pre-defined color temperature and/or brightness, and generating a model that is a best fit for the plurality of lights 104 when diffuser 112-N is installed. During manufacturing of lights 104 of the same type, diffuser model 114-N may be stored at their corresponding controllers 106 (e.g., compiled into the firmware of controller 106), and calibrating individual lights 104 for diffuser 112-N during the subsequent production process may not be needed.

In some embodiments, diffuser models 114 are updated (e.g., by the end-user) after light 104 is manufactured and placed in service. For example, the end-user may operate user device 102 to download new diffuser models 114 if new diffusers 112 become available for light 104 and/or to download updates to diffuser models 114 that improve the performance of light 104. In another example, the end-user may update the firmware on controller 106, and the new firmware may include new diffuser models 114 that correspond to new diffusers 112 that become available for light 104 and/or may include updates to diffuser models 114 that improve the performance of light 104.

In one embodiment, the end-user may operate user interface 108 and/or user device 102 to select which of diffusers 112 are installed at light 104. For example, when replacing diffusers 112 at light 104, the end-user may operate user device 102 and/or user interface 108 to inform controller 106 of the change in diffuser 112 installed at light 104, and in response, controller 106 selects a different diffuser model 114 to modify the operation of LED(s) 110 to adjust the color temperature and/or brightness of light 104, thereby ensuring that light 104 maintains the same or similar color temperature and/or brightness when diffusers 112 are replaced at light 104.

In another embodiment, controller 106 automatically detects the change in diffusers 112 at light 104, and automatically selects a different diffuser model 114 to modify the operation of LED(s) 110 and adjust the color temperature and/or brightness of light 104, thereby ensuring that light 104 maintains the same or similar color temperature and/or brightness when a new diffuser 112 is installed at light 104. For example, controller 106 may utilize one or more sensors 116 in light 104 to determine which of diffusers 112 are installed at light 104 and select the appropriate diffuser model 114 based on the determination. Sensors 116 may include, in various embodiments, radio frequency identification devices, pogo pin detectors (e.g., spring-loaded pin detectors), logic signal detectors, and/or any mechanical and/or electrical arrangement that is suitable for use by controller 106 to determine which of diffusers 112 are installed at light 104.

In embodiments where sensors 116 comprise radio frequency identification (RFID) detectors, diffusers 112 may include RFID devices that are read by sensors 116 when diffusers 112 are installed at light 104, and controller 106 selects the appropriate diffuser model 114 based on the information read from diffusers 112. In embodiments where sensors 116 comprise pogo pin detectors/spring-loaded contacts, diffusers 112 may include mechanical features that depress the pogo pins/spring-loaded contacts at light 104 that vary depending on which of diffusers 112 are installed at light 104, and controller 106 selects the appropriate diffuser model 114 based on the pogo pins/spring-loaded contacts depressed at light 104 by diffusers 112. In embodiments where sensors 116 comprise logical signal detectors, diffusers 112 may include features that vary logic signals at sensors 116 (e.g., pull-up resistors, and/or pull-down resistors, and/or conductors) that vary depending on which of diffusers 112 are installed at light 104, and controller 106 selects the appropriate diffuser model 114 based on the logic level signals modified at light 104 by diffusers 112.

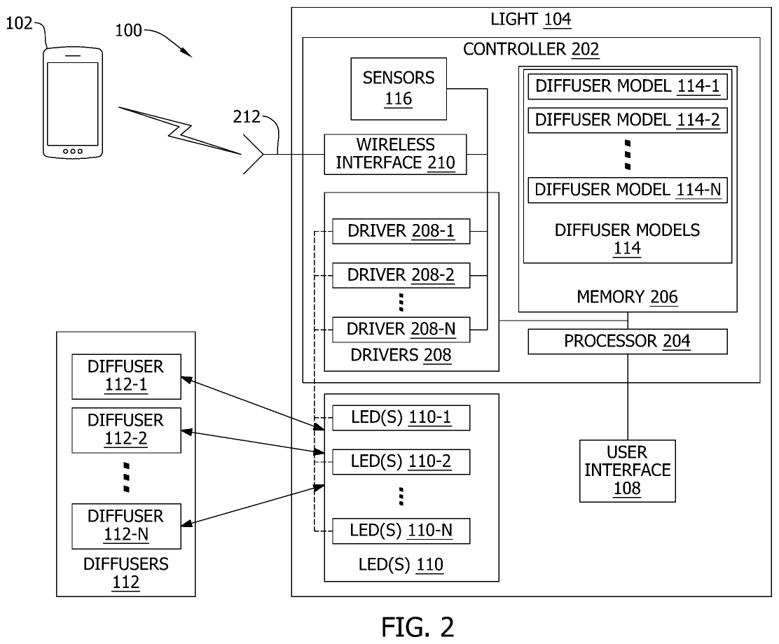

FIG. 2 depicts a block diagram of a controller 202 for light 104 in another exemplary embodiment. Controller 202 comprises any component, system, or device that performs the functionality described herein for controller 202. Controller 202 will be described with respect to various discrete elements, which perform functions. These elements may be combined in different embodiments, segmented into different discrete elements in other embodiments, or removed in some embodiments. Controller 202 may operate the same or similar as to controller 106 as described with respect to FIG. 1. Therefore, the functionality described previously with respect to controller 106 applies equally to controller 202.

In this embodiment, controller 202 includes one or more processors 204 communicatively coupled with a memory 206. In some embodiments, processor 204 executes programmed instructions (e.g., which may be stored at memory 206) in order to perform the functionality described herein for controller 202. In other embodiments, processor 204 and/or memory 206 may comprise logic that implements the functionality described herein for controller 202.

In this embodiment, controller 202 further includes drivers 208 and a wireless interface 210. Drivers 208 are configured to modify the operation of LED(s) 110. In particular, three drivers 208-1, 208-2, 208-N are illustrated in FIG. 2, each configured to modify the operation of a corresponding LED(s) 110-1, 110-2, 110-N. However, in other embodiments, light 104 includes a different number of drivers 208-1, 208-2, 208-N and their corresponding LED(s) 110-1, 110-2, 110-N.

Wireless interface 210 in this embodiment is communicatively coupled to an antenna 212. Antenna 212 may be external to controller 202 and/or internal to controller 202 in different embodiments.

Wireless interface 210 may include, for example, Wi-Fi interfaces, Bluetooth interfaces, near field communication (NFC) interfaces, and combinations thereof. In this embodiment, processor 204 utilizes wireless interface 210 to communicate with user device 102. For example, processor 204 may receive a selection from the end-user as to which diffuser 112 (see FIG. 1) is installed at light 104, and/or may receive updates to diffuser models 114 for light 104 from user device 102 via wireless interface 210 and store the updates in memory 206. In some embodiments, controller 202 includes one or more wired interfaces (not shown), which allows controller 202 to communicate with external devices (e.g., a computer operated by the end-user) via a wired network (e.g., via Ethernet).

In this embodiment, drivers 208 are used to operate LED(s) 110 of light 104. Processor 204 therefore may utilize drivers 208 in a number of different ways to control LED(s) 110. For instance, drivers 208 may comprise multi-channel LED drivers, with each of drivers 208-1, 208-2, 208-N controlling a different color of LED(s) 110. Thus, processor 204, using drivers 208, is configured in some embodiments to operate each color of LED(s) 110 individually. For example, processor 204 may control each color of LED(s) 110 and individually or collectively, adjust a brightness, a hue, and a saturation of LED(s) 110 based on diffuser models 114.

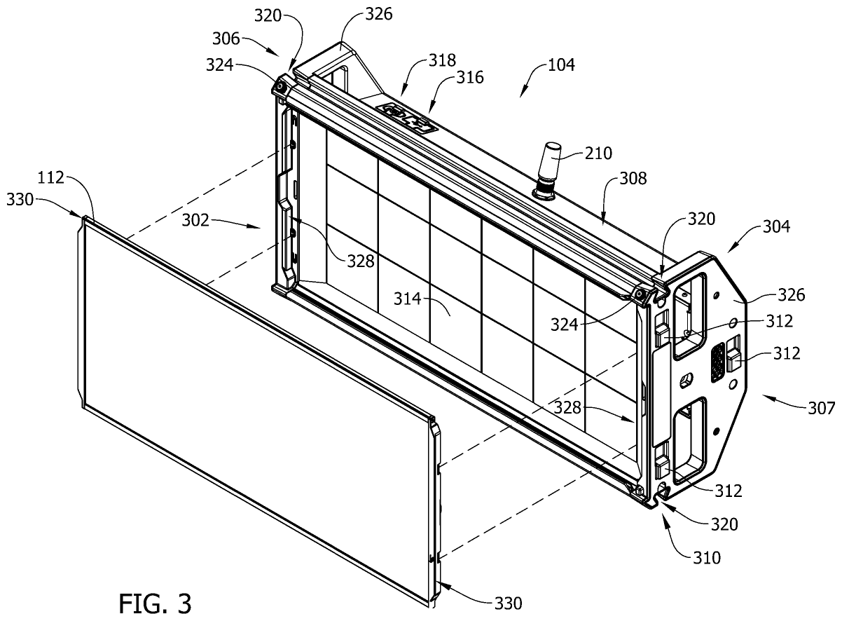

FIG. 3 is an orthographic view of light 104 and diffuser 112 in an exemplary embodiment. Although FIG. 3 illustrates that light 104 and diffuser 112 have a particular shape and configuration, light 104 and diffuser 112 have different shapes and/or configurations in other embodiments. Thus, the specific shape and configuration of light 104 and diffuser 112 in FIG. 3 and subsequent figures are provided simply for purposes of discussion.

In this embodiment, light 104 includes a front portion 302, a rear portion 304, side portions 306, 307, a top portion 308, and a bottom portion 310. Front portion 302 is configured to accept and removably retain diffuser 112. Side portions 306, 307 are configured to removably engage with additional lights 104 as needed. In particular, side portions 306, 307 include interlocks 312 which removably engage with side portions 306, 307 of other lights 104, not shown, thereby allowing multiple lights 104 to be joined together into a row.

In this embodiment, front portion 302 of light 104 includes one or more LED assemblies 314, each comprising one or more LEDs (e.g., LED(s) 110, not shown) and a lens. Only the lens is visible in LED assembly 314. The lens is used, for example, to collate and focus the optical output of the underlying LED(s) towards diffuser 112.

In this embodiment, light 104 includes a universal communication port 316 and a universal serial bus (USB) port 318 disposed along top portion 308 of light 104, each of which may be used to communicate with controllers 106, 202 (see FIGS. 1, 2) of light 104.

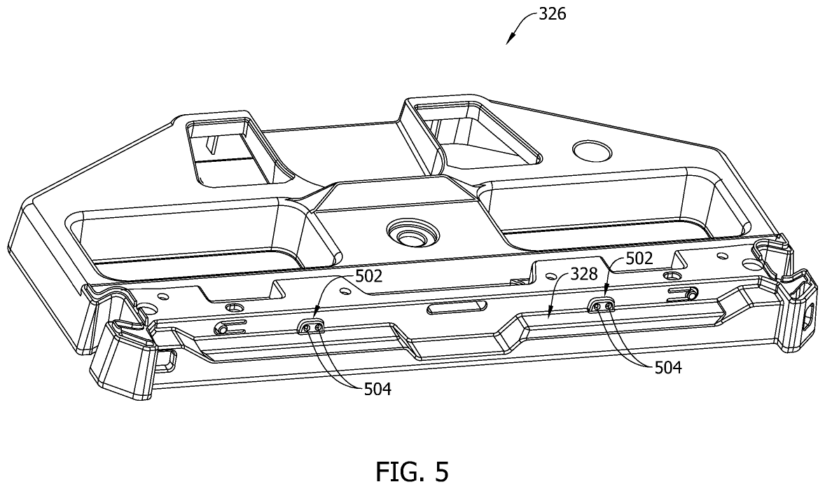

In this embodiment, light 104 includes dovetail channels 320 in side portions 306, 307 that extend along top portion 308 and bottom portion 310 of light 104. Dovetail channels 320 may be used to vertically interlock multiple lights 104 together in a column. In this embodiment, diffuser 112 is removably secured to light 104 using latches 324 which are located on side portions 306, 307 of light 104 proximate to top portion 308 of light 104. In this embodiment, light 104 includes side panels 326 disposed on each of side portions 306, 307. Side panels 326 include inside surfaces 328 that engage with outside surfaces 330 of diffuser 112. Side panels 326 will be discussed in more detail with respect to FIG. 5.

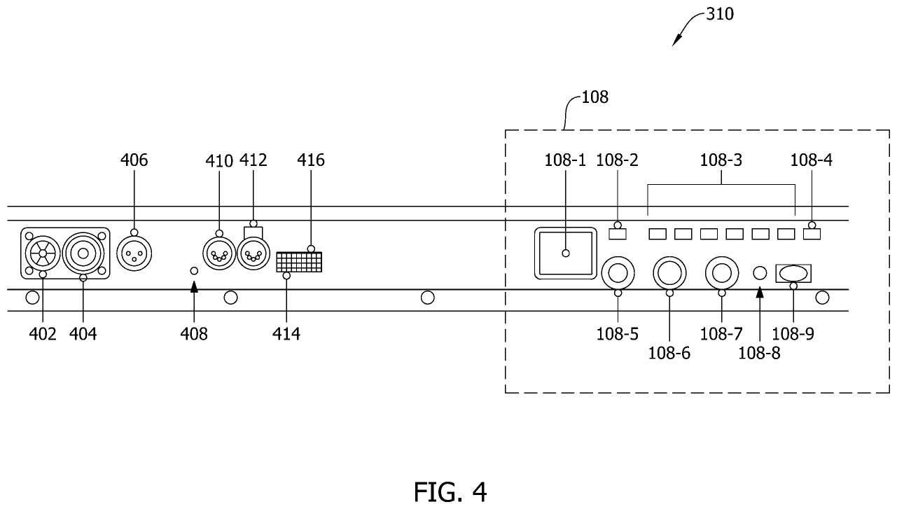

FIG. 4 depicts bottom portion 310 of light 104 in an exemplary embodiment. In this embodiment, light 104 further includes, from left to right in FIG. 4, an alternating current (AC) power input 402, an AC power pass-through 404 (which may be wired to other downstream lights 104, not shown), a direct current (DC) power input jack 406, a communication indicator light 408, a five pin XLR digital multi-plex (DMX) input 410, a five pin XLR DMX output 412 (which may be wired to other downstream lights 104, not shown), an RJ45 DMX input 414, an RJ45 DMX output 416 (which may be wired to other downstream lights 104, not shown), and user interface 108. In this embodiment, user interface 108 includes a display 108-1, a cancel button 108-2, preset buttons 108-3, a preset toggle button 108-4, a green offset/hue menu knob 108-5, a CCT/saturation knob 108-6, a dimmer/intensity knob 108-7, a power/status indicator light 108-8, and an on/off switch 108-9, each of which may be used to by an end-user modify the operation of light 104 and/or indicate to controllers 106, 202 of light 104 which of diffusers 112 are installed at light 104.

FIG. 5 is an orthographic view of side panel 326 of light 104 in an exemplary embodiment. In this view, the inside surface 328 of side panel 326 is visible, where outside surface 330 of diffuser 112 (see FIG. 3) engages with side panel 326. In this embodiment, side panel 326 includes pogo pin assemblies 502, each including a pair of pogo pins 504. Pogo pins 504 may be referred to as spring-loaded contacts in some embodiments. In this embodiment, pogo pins 504 are depressed by mechanical features (e.g., projections, not shown) on diffusers 112, which are used by controllers 106, 202 (e.g., via sensors 116) to identify the type of diffuser 112 installed at light 104. Because two of side panels 326 are installed at light 104, pogo pins 504 may decode up to eight bits of information for identifying different types of diffusers 112 installed at light 104.

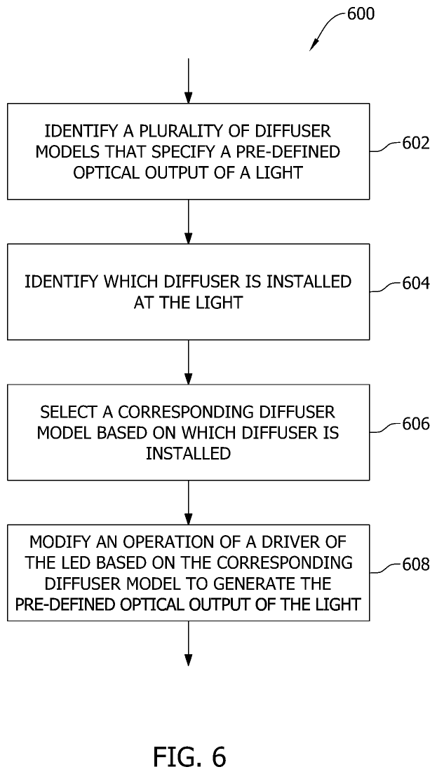

FIG. 6 depicts a flow chart of a method 600 of dynamically adjusting an optical output of a light in an exemplary embodiment. Method 600 will be discussed with respect to system 100 and controllers 106 and 202 of FIG. 1 and FIG. 2, respectively, although method 600 may be performed by other systems, not shown.

In this embodiment, method 600 includes identifying 602 a plurality of diffuser models that specify a pre-defined optical output of the light, where each diffuser model corresponds to a different one of a plurality of diffusers installable at the light. In some embodiments, the pre-defined output comprises a pre-defined color temperature of the light and/or a pre-defined brightness of the light. In one example, controllers 106, 202 identify diffuser models 114-1, 114-2, 114-N, corresponding to diffusers 112-1, 112-2, 112-N (see FIGS. 1, 2). In another example, processor 204 of controller 202 identifies diffuser models 114-1, 114-2, 114-N, corresponding to diffusers 112-1, 112-2, 112-N (see FIG. 2).

Method 600 continues in this embodiment by identifying 604, from the plurality of diffusers installable at the light, which diffuser of the plurality of diffusers is installed. In one example, controllers 106, 202 identify diffusers 112-1, 112-2, 112-N installed at light 104 (see FIGS. 1, 2). In another example, processor 204 of controller 202 identifies diffusers 112-1, 112-2, 112-N installed at light 104 (see FIG. 2).

In some embodiments, the diffuser installed at the light is identified using one or more sensors that interact with the diffuser. For example, the diffusers may include one or more mechanical components, electrical components, radio frequency components, which are detected by the sensors and used to identify which of the diffusers is installed at the light. In one example, controllers 106, 202 identify diffusers 112-1, 112-2, 112-N installed at light 104 utilizing sensors 116 (see FIGS. 1, 2). In another example, processor 204 of controller 202 identifies diffusers 112-1, 112-2, 112-N installed at light 104 utilizing sensors 116 (see FIG. 2).

In other embodiments, the diffuser installed at the light is identified by an end-user of the light. In one example, controllers 106, 202 identify diffusers 112-1, 112-2, 112-N installed at light 104 utilizing user interface 108 and/or user device 102, which the end-user operates to select one of the diffusers 112-1, 112-2, 112-N installed at light 104 (see FIGS. 1, 2). In another example, processor 204 of controller 202 identifies diffusers 112-1, 112-2, 112-N installed at light 104 utilizing user interface 108 and/or user device 102, which the end-user operates to select one of the diffusers 112-1, 112-2, 112-N installed at light 104 (see FIG. 2).

Method 600 continues in this embodiment by selecting 606 a corresponding diffuser model of the plurality of diffuser models based on which diffuser is installed. In one example, controllers 106, 202 select diffuser models 114-1, 114-2, 114-N based on which diffuser 112-1, 112-2, 112-N is installed at light 104 (see FIGS. 1, 2). In another example, processor 204 of controller 202 selects diffuser models 114-1, 114-2, 114-N based on which diffuser 112-1, 112-2, 112-N is installed at light 104. For instance, controllers 106, 202, and/or processor 204 may select diffuser model 114-1 in response to identifying that diffuser 112-1 is installed at light 104, may select diffuser model 114-2 in response to identifying that diffuser 112-2 is installed at light 104, and may select diffuser model 114-N in response to identifying that diffuser 112-N is installed at light 104.

Method 600 continues in this embodiment by modifying 608 an operation of at least one driver of the at least one LED based on the corresponding diffuser model to generate the pre-defined optical output at the light. In one example, controller 202 modifies the operation of one or more drivers 208 based on the corresponding diffuser model 114 to generate the pre-defined optical output at light 104 depending on which of diffusers 112 are installed at light 104. In another example, processor 204 modifies the operation of one or more drivers 208 based on the corresponding diffuser model 114 to generate the pre-defined optical output at light 104. For instance, controller 202 or processor 204 may modify the operation of one or more of drivers 208-1, 208-2, 208-N based on diffuser model 114-1 when diffuser 112-1 is installed at light 104, may modify the operation of one or more of drivers 208-1, 208-2, 208-N based on diffuser model 114-2 when diffuser 112-2 is installed at light 104, and may modify the operation of one or more of drivers 208-1, 208-2, 208-N based on diffuser model 114-N when diffuser 112-N is installed at light 104.

The use of diffuser models 114, which are used to control the operation of LEDs 110 based on which of diffusers 112 are installed at light 104, provides color temperature correction and/or brightness correction at light 104, regardless of which diffuser 112 is installed at light 104, thereby improving the performance of light 104.

An example technical effect of the embodiments described herein includes at least one of: (a) improving the optical output accuracy of LED lighting when removable diffusers are used; and (b) improving the manufacturing efficiency of LED lighting using diffuser models that are generated as a best fit across variety of LED lighting of the same type, which reduces the calibration steps needed when manufacturing a LED light.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A controller for dynamically adjusting an optical output of a light, the controller comprising:
at least one driver configured to modify an operation of at least one light emitting diode (LED) of the light;
a memory configured to store a plurality of diffuser models that specify a pre-defined optical output of the light, wherein each diffuser model corresponds to a different one of a plurality of diffusers installable at the light; and
at least one processor configured to:
identify, from the plurality of diffusers installable at the light, which diffuser of the plurality of diffusers is installed at the light;
select a corresponding diffuser model of the plurality of diffuser models based on which diffuser is installed; and
modify the operation of the at least one driver based on the corresponding diffuser model to generate the pre-defined optical output of the light.

2. The controller of claim 1, wherein:
the pre-defined optical output comprises a pre-defined color temperature.

3. The controller of claim 1, wherein:
the pre-defined optical output comprises a pre-defined brightness.

4. The controller of claim 1, further comprising:
at least one sensor configured to interact with the diffuser when the diffuser is installed at the light,
wherein the at least one processor is further configured to identify, utilizing the at least one sensor, the diffuser.

5. The controller of claim 4, wherein:
the at least one sensor is configured to interact with one or more mechanical components of the diffuser when the diffuser is installed at the light, and
the at least one processor is further configured to identify, utilizing the at least one sensor interacting with the one or more mechanical components, the diffuser.

6. The controller of claim 4, wherein:
the at least one sensor is configured to interact with one or more electrical components of the diffuser when the diffuser is installed at the light, and
wherein the at least one processor is further configured to identify, utilizing the at least one sensor interacting with the one or more electrical components, the diffuser.

7. The controller of claim 4, wherein:
the at least one sensor is configured to interact with one or more radio frequency components of the diffuser when the diffuser is installed at the light, and
wherein the at least one processor is further configured to identify, utilizing the at least one sensor interacting with the one or more radio frequency components, the diffuser.

8. The controller of claim 1, wherein:
the at least one processor is further configured to receive, via a user interface of the light, a selection from an end-user to identify the diffuser installed at the light.

9. A method of dynamically adjusting an optical output of a light, the method comprising:
identifying a plurality of diffuser models that specify a pre-defined optical output of the light, wherein each diffuser model corresponds to a different one of a plurality of diffusers installable at the light;
identifying, from the plurality of diffusers installable at the light, which diffuser of the plurality of diffusers is installed at the light;
selecting a corresponding diffuser model of the plurality of diffuser models based on which diffuser is installed; and
modifying an operation of at least one driver of at least one light emitting diode (LED) of the light based on the corresponding diffuser model to generate the pre-defined optical output of the light.

10. The method of claim 9, wherein:
the pre-defined optical output comprises a pre-defined color temperature.

11. The method of claim 9, wherein:
the pre-defined optical output comprises a pre-defined brightness.

12. The method of claim 9, wherein identifying the diffuser further comprises:
identifying, utilizing at least one sensor configured to interact with the diffuser when the diffuser is installed at the light, the diffuser.

13. The method of claim 12, wherein identifying the diffuser further comprises:
identifying, utilizing the at least one sensor, one or more mechanical components of the diffuser when the diffuser is installed at the light.

14. The method of claim 12, wherein identifying the diffuser further comprises:
identifying, utilizing the at least one sensor, one or more electrical components of the diffuser when the diffuser is installed at the light.

15. The method of claim 12, wherein identifying the diffuser further comprises:
identifying, utilizing the at least one sensor, one or more radio frequency components of the diffuser when the diffuser is installed at the light.

16. The method of claim 9, wherein identifying the diffuser further comprises:
receiving, via a user interface at the light, a selection from an end-user of the diffuser installed at the light.

17. A system, comprising:
a light comprising at least one light emitting diode (LED);
a plurality of diffusers, each installable at the light in an optical output path of the at least one LED;
a controller comprising:
at least one driver configured to modify an operation of the at least one LED; and
a memory configured to store a plurality of diffuser models that specify a pre-defined optical output of the light, wherein each diffuser model corresponds to a different one of the plurality of diffusers installable at the light,
wherein the controller is configured to:
identify, from the plurality of diffusers installable at the light, which diffuser of the plurality of diffusers is installed at the light;
select a corresponding diffuser model of the plurality of diffuser models based on which diffuser is installed; and
modify the operation of the at least one driver based on the corresponding diffuser model to generate the pre-defined optical output of the light.

18. The system of claim 17, wherein:
the pre-defined optical output comprises at least one of a pre-defined color temperature and a pre-defined brightness.

19. The system of claim 17, wherein:
each of the plurality of diffusers further comprises at least one of an electrical interface, a radio frequency interface, and a mechanical interface,
the controller further includes at least one sensor configured to interact with one or more of the electrical interface, the radio frequency interface, and the mechanical interface when the diffuser is installed at the light, and
the controller is further configured to identify, utilizing the at least one sensor, the diffuser installed at the light.

20. The system of claim 19, wherein:
each of the plurality of diffusers further comprises the mechanical interface,
the mechanical interface includes at least one projection,
the at least one sensor comprises at least one spring-loaded contact, and
the at least one projection is configured to depress the at least one spring-loaded contact when the diffuser is installed at the light to identify the diffuser.
